(19) United States
(12) Patent Application Publication
(10) Pub. No.: US 2008/0190708 A1
(43) Pub. Date: Aug. 14, 2008

(54) Elevator door operator

(75) Inventor: Brad L. Fisher, Boynton Beach, FL (US)

Correspondence Address: ROBERT M. DOWNEY, P.A., 6751 N. FEDERAL HWY., SUITE 300, BOCA RATON, FL, 33487, US

(73) Assignee: Atlantic Tech System, LLC

(21) Appl. No.: 11/704,619

(22) Filed: Feb. 9, 2007

(51) Int. Cl. B66B 13/06

(52) U.S. Cl. 187/324

(57) ABSTRACT

An elevator door operator is disclosed according to several embodiments, including a single speed (i.e. single door) operator, a two speed (i.e. two door) operator and a center opening door operator. In each embodiment, the components of the door operator, including a drive motor, cog belt and pulleys, limit switches, a gate switch, door tracks and hangers, and mounting brackets, are pre-assembled, wired, and leveled as a one-piece integral unit on an elongate header plate, thereby allowing for quick and easy installation, repair and replacement. A computer controller with a self-contained LED display screen allows for onboard diagnostics and changing of operating parameters without the need for a laptop computer or other externally connected devices.

### BACKGROUND OF THE INVENTION

1. Field of the Invention

This invention relates to elevator door operators and, more particularly, to a pre-assembled integral elevator door operator and onboard computer controller that allows for quick and easy installation, repair, adjustment and replacement of the door operator system.

2. Discussion of the Related Art

In the field of elevator design and manufacturing, it is generally desirable to provide an elevator door operator system that is rugged to withstand constant usage, and designed to be compact to fit within the elevator hoistway. Several elevator door operating systems meeting these objectives are commercially available.

In addition to the above objectives, it is equally desirable to provide a door operator design and assembly that is easy to install, service and replace in a manner that leaves little opportunity for human error. In particular, eliminating the need to individually install the door operator components, as well as the need to wire and connect the components and level the door tracks would significantly improve the efficiency and operational reliability of an elevator door operating system.

U.S. Pat. No. 5,878,846 to O'Donnell discloses an elevator door operator having an arrangement of parts including a drive motor, cog belt and pulleys, a drive bar, a pair of spaced apart relating pulleys, a relating cable, door tracks and hangers. Most of these parts are assembled and attached to a header plate at the installation site by an elevator service person/installer. The installer must mount these parts to the header plate, mount and level the door tracks and wire the components. Due to limitations associated with field assembly, including the lack of precision assembly tools, machinery and equipment, as well as human error, elevator operational problems are common after installation of the door operator. For instance, the tracks may not be perfectly level and parallel or the components may not be mounted properly or wired correctly. This can lead to numerous service calls subsequent to the original installation in order to correct operational problems. The need for repeated service calls to correct installation errors is costly and inconvenient for both the elevator service company and the building owner and occupants.

### SUMMARY OF THE INVENTION

The present invention is directed to a door operator for an elevator. The elevator door operator is disclosed according to several embodiments of the invention, including a single speed door operator, a two speed door operator and a center opening door operator. In each embodiment, the components of the door operator are pre-assembled and wired as a one-piece integral unit on an elongate header plate. The components include, but are not limited to, a drive motor, a cog belt and pulleys, limit switches, door tracks and hangers, a gate switch and mounting brackets.

An onboard controller includes a self-contained LED display screen. The controller enables onboard diagnostics and changing of operating parameters without the need for a laptop computer or some other externally connected device.

### OBJECTS AND ADVANTAGES OF THE INVENTION

Considering the foregoing, it is a primary object of the present invention to provide a door operator for an elevator that is easy to install, repair, replace and adjust with minimal chance of human error.

It is another object of the present invention to provide a door operator for an elevator that is pre-assembled, thereby eliminating the need for an installer to connect and wire the components.

It is another object of the present invention to provide a door operator for an elevator that is pre-assembled as a one piece unit, thereby eliminating the need of the installer to level the door tracks and greatly minimizing the possibility of human error during installation.

It is still a further object of the present invention to provide a door operator for an elevator that is designed to facilitate ease of service.

It is still a further object of the present invention to provide a door operator for an elevator that is pre-assembled as a one piece, integral unit including a drive motor, a cog belt and pulley drive arrangement, limit switches, door tracks and hangers, a gate switch and mounting brackets, all installed and pre-wired on a header plate.

It is still a further object of the present invention to provide an onboard computer controller on an elevator car, wherein the computer controller includes a self-contained LED display screen for onboard diagnostics and changing of operating parameters without the need for a laptop computer or other externally connected device.

These and other objects, features and advantages of the present invention are readily apparent from the following detailed description and accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a front view of a single speed elevator door operator, in accordance with one embodiment of the invention;

FIG. 1A is a side elevational view of the single speed elevator door operator of FIG. 1;

FIG. 2 is a front view of a two speed elevator door operator, in accordance with another embodiment of the invention;

FIG. 2A is a side elevational view of the two speed elevator door operator of FIG. 2;

FIG. 3 is front view of a center opening elevator door operator, in accordance with yet another embodiment of the invention;

FIG. 3A is a side elevational view of the center opening elevator door operator of FIG. 3;

FIG. 4 is a top plan view of an elevator door controller board;

FIG. 5 is a schematic diagram of the controller board;

FIG. 6 is a further schematic diagram of the elevator door controller board;

FIG. 7 is yet a further schematic diagram of the controller board; and

FIG. 8 is a top perspective view of the elevator door controller board, including an LED display.

Like reference numerals refer to like parts throughout the several views of the drawings.

### DETAILED DESCRIPTION OF THE PREFERRED EMBODIMENTS

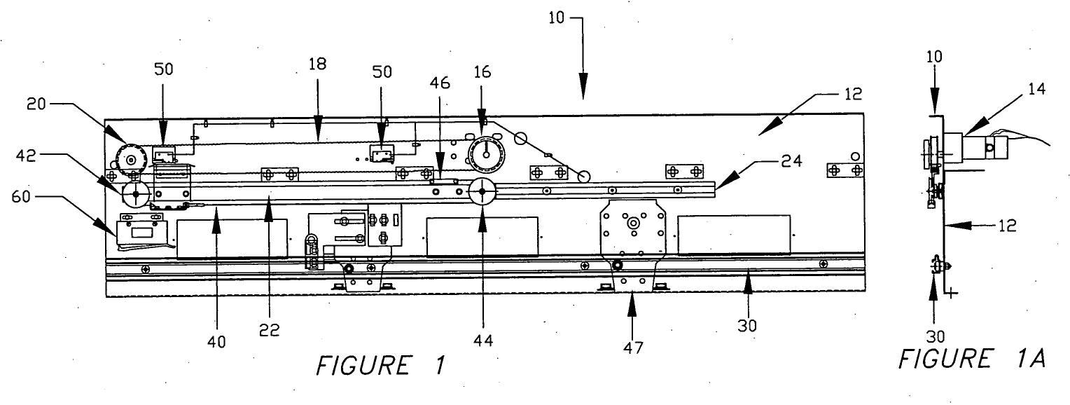

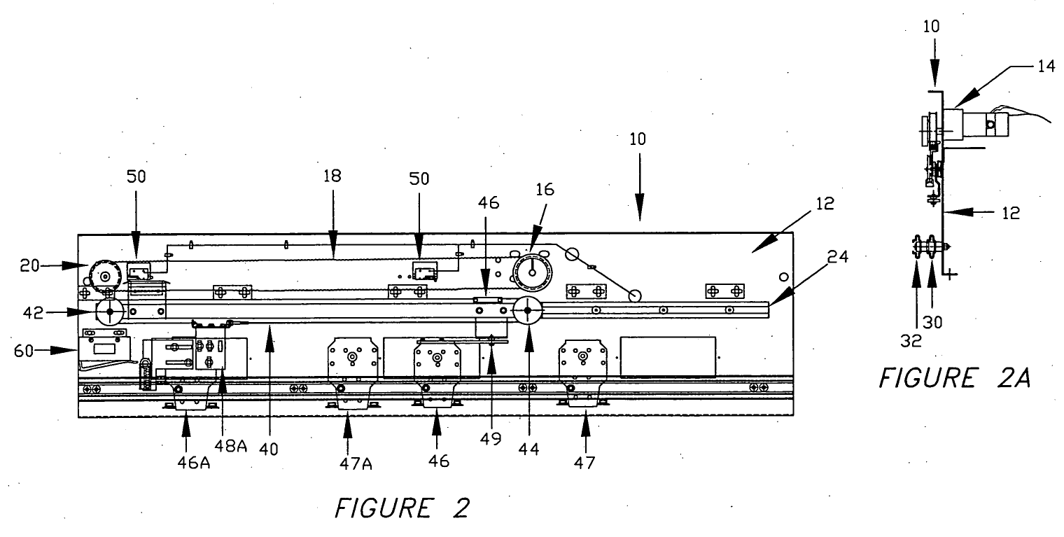

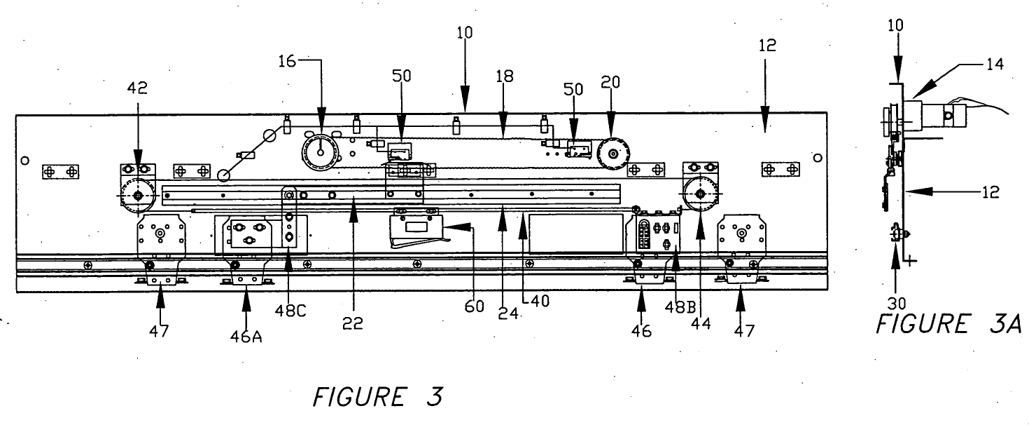

Referring to the several drawing figures, the elevator door operator is shown according to several embodiments, including a single speed door operator in FIGS. 1 and 1A, a two speed door operator in FIGS. 2 and 2A, and a center opening door operator in FIGS. 3 and 3A. In each embodiment, the door operator, generally indicated as 10, includes a header plate 12. The operating components of the elevator door operator 10 are mounted to the header plate 12.

The components of the elevator door operator 10 include a drive motor 14, a drive pulley 16 mounted for rotation by the drive motor 14, a continuous loop cog belt 18 looped on the drive pulley and around an idler pulley 20. The components further include a drive bar 22 slideably mounted on a bar guide 24 for translational movement across the elevator door opening. Drive bar 22 is connected to the cog belt 18 so that the motion of the cog belt 18 is directly transmitted to the sliding drive bar.

The one or more doors are slideably mounted on door tracks for movement between an open position and a closed position. Each door is supported on two separate hangers that move within the door tracks. The single speed door operator moves one door and includes a single door track 30 mounted to the header plate 12. The two speed door operator is moves two doors and includes a pair of door tracks 30,32 mounted to the header plate 12 in overlying, parallel and spaced relation to one another. The door tracks 30,32 remain in fixed position relative to the elevator car.

A relating cable 40 is looped around a pair of relating pulleys 42,44 that are mounted on the moving drive bar 22. The relating cable 40 is also secured to the header plate 12 via a linkage 46, so that as the drive bar 22 slides on the bar guide 24, the cable 40 is repositioned relative to the moving drive bar 22.

In the single speed door operator, as shown in FIG. 1, a door (not shown) is connected via the hanger 46 and a bracket 48 to the relating cable 40. As the cog belt 18 drivingly moves the drive bar 22, the door is pulled via the interconnection of the hanger 46 to relating cable 40. The door is also supported on a second hanger 47.

In the two speed door operator, as seen in FIG. 2, one of the doors (not shown) is connected directly to the drive bar 22 via the door hanger 46 and a bracket 49 so that the motion of the sliding drive bar 22 is directly transmitted to the door. This door is also supported on a second hanger 47. The second of the two doors (also not shown) is connected to the relating cable 40 via the hanger 46a and a bracket 48a. The second door is also supported on a second hanger 47a. This allows the second door to move in the same direction as the first door, except at a relatively faster speed due to movement of both the drive bar 22 and the relating cable 40 linkage relative to the stationary header plate 12.

Another embodiment of the elevator door operator of the present invention is shown in FIGS. 3 and 3A. In this embodiment, the drive motor 14, drive pulley 16, cog belt 18, idler pulley 20, drive bar 22, bar guide 24 and two-to-one relating cable 40 assembly remain the same as shown in FIG. 2, as described above. To achieve a center opening operation in which the doors move away from one another to open and towards each other to close, a first door (not shown) is connected to one leg of the two-to-one relating cable 40 via a hanger 46 cable bracket 48b. The second door (also not shown) is drivingly connected to an opposite leg of relating cable 40 via hanger 46a and a cable bracket 48c. The first door is connected to one leg of the relating cable. This arrangement results in the translation of movement of the first door in one direction which drives the cable on the pulleys to move the second door at the same speed but in the opposite direction. The hangers for both doors move along the same single track 30.

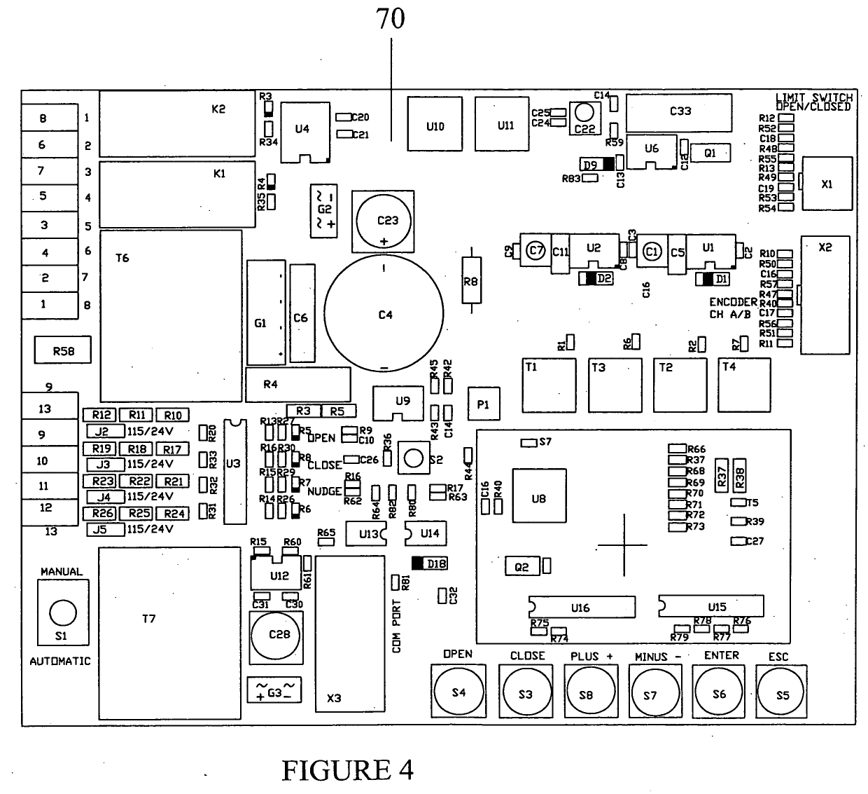

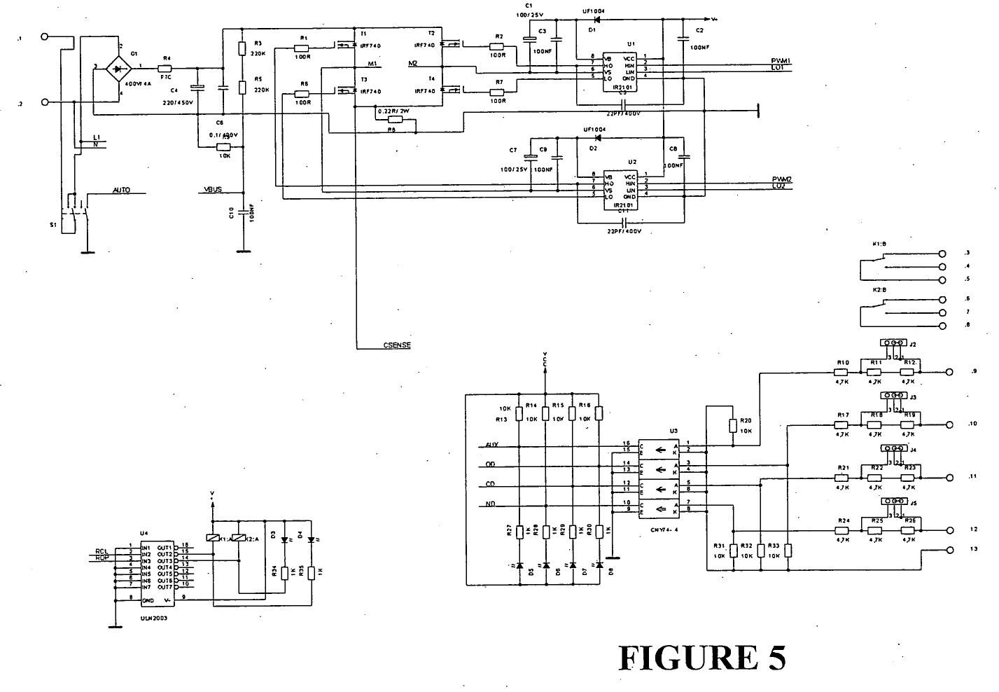

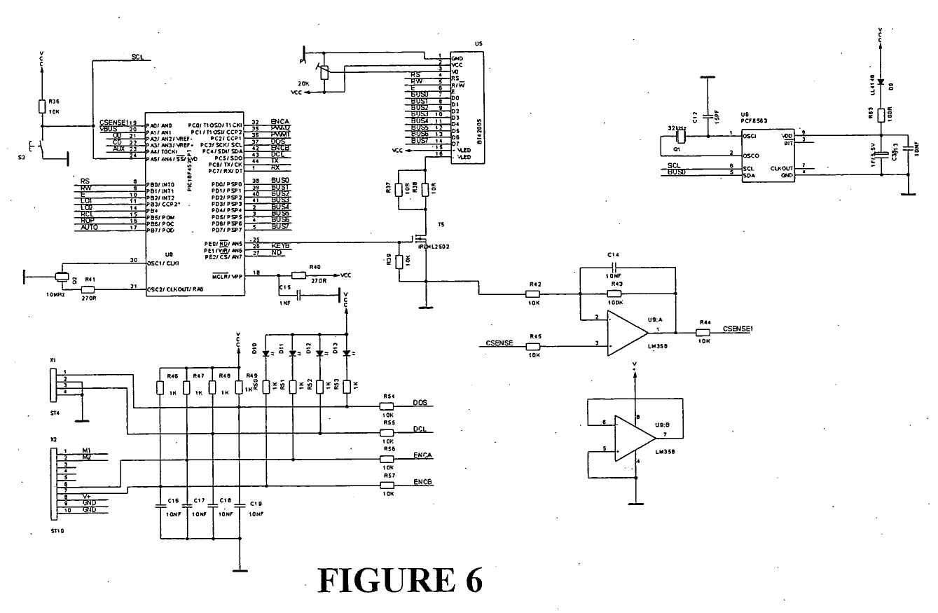

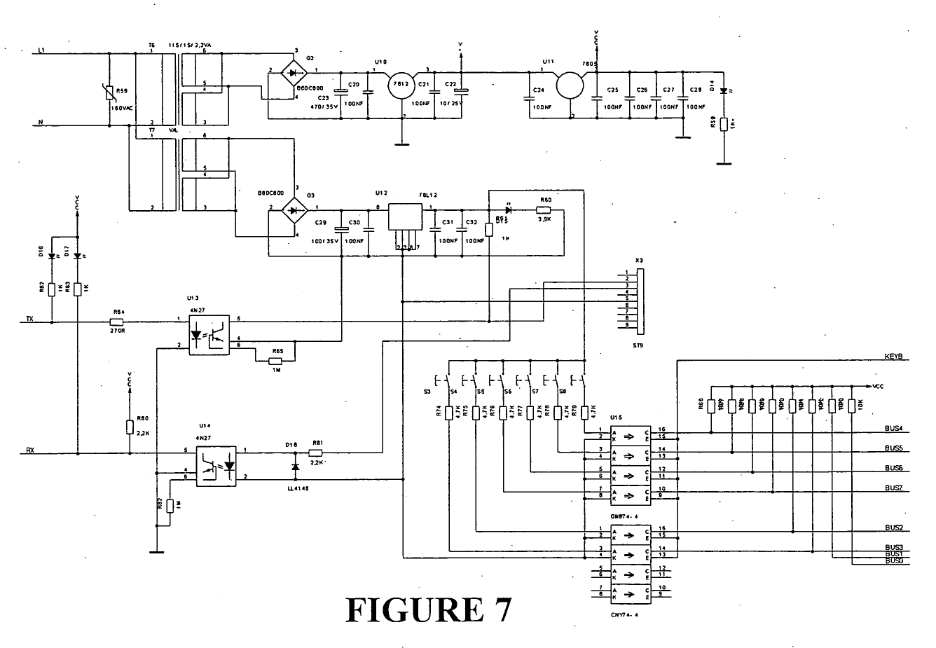

In each of the embodiments, as described above, limit switches 50 are provided for detecting movement of the drive bar 22 to the fully open and fully closed positions. Additionally, a gate switch 60 is provided to sense when the doors are open and fully closed. The limit switches 50 and the gate switch 60 communicate with a computer controller 70 (shown in FIGS. 4-8) which outputs an electric signal to the drive motor 14 in order to operate the motor at a desired speed and direction.

In each of the embodiments, as described above, all of the components, including the drive motor 14, cog belt 18 and pulleys 16,20, drive bar 22 and bar guide 24, relating cable 40 and pulleys 42,44, limit switches 50, gate switch 60, door tracks 30,32 and mounting brackets are supported as a one piece unit on the header plate 12.

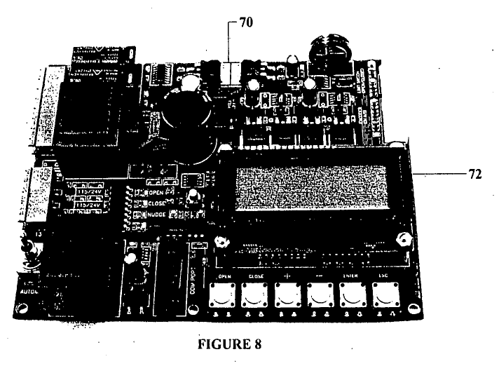

The limit switches 50, gate switch 60 and drive motor 14 communicate with the onboard computer controller 70. The computer controller 70 includes a self-contained LED display screen 72, as seen in FIG. 8. The computer controller 70 is adapted for running onboard diagnostics, inputting operating parameters, and changing or adjusting operating parameters, all without the need for a laptop computer or other externally connected device.

While present invention has been shown and described in accordance with preferred and impractical embodiments thereof, it is recognized that departures from the instant disclosure are contemplated within the spirit and scope of the present invention.

What is claimed is:

1. An elevator door operator comprising:
an elongate header plate;
an arrangement of components assembled and arranged on said header plate as an integral unit and comprising:
at least one door guide track mounted and leveled in fixed position on said header plate;
a drive motor mounted to said header plate;
a drive pulley mounted on said header plate and structured and disposed for driven rotation by the drive motor;
an idler pulley mounted to said header plate and spaced from the drive pulley;
a continuous loop cogbelt drivingly engaged on the drive pulley and the idler pulley;
an elongate bar guide on said header plate;
a drive bar slideably mounted on the bar guide and connected to the cogbelt so that motion of the cogbelt is directly transmitted to the drive bar for translational movement of the drive bar along the bar guide;
at least two door hangers slideably mounted on the at least one door guide track, the at least two door hangers being structured and disposed for supporting at least one elevator door;
a pair of spaced apart relating pulleys mounted at fixed positions relative to the drive bar;
a continuous loop relating cable fitted taut about the relating pulleys;
a linkage connecting the relating cable in a fixed position on the header plate;
a bracket connecting one of the at least two door hangers to the relating cable, wherein motion of the drive bar along the bar guide results in translational movement of the one of the at least two door hangers along the at least one door guide track;
at least two limit switches mounted in fixed position on said header plate for detecting movement of the drive bar to a fully open position and a fully closed position; and
a gate switch mounted in fixed position on said header plate for sensing movement of a leading one of said door hangers to a fully closed position on the door guide track.

2. An elevator door operator comprising:
an elongate header plate;
an arrangement of components assembled and arranged on said header plate as an integral unit and comprising:
a pair of door guide tracks, including a first door guide track and a second door guide track, said pair of door guide tracks being mounted and leveled in fixed, parallel and overlying position on said header plate;
a drive motor mounted to said header plate;
a drive pulley mounted on said header plate and structured and disposed for driven rotation by the drive motor;
an idler pulley mounted to said header plate and spaced from the drive pulley;
a continuous loop cogbelt drivingly engaged on the drive pulley and the idler pulley;
an elongate bar guide on said header plate;
a drive bar slideably mounted on the bar guide and connected to the cogbelt so that motion of the cogbelt is directly transmitted to the drive bar for translational movement of the drive bar along the bar guide;
at least four door hangers, including a first door hanger and a second door hanger slideably mounted on the first door guide track, and a third door hanger and a fourth door hanger slideably mounted on the second door guide track, the first and second door hangers being structured and disposed for supporting a first elevator door and the third and fourth door hangers being structured and disposed for supporting a second elevator door;
a pair of spaced apart relating pulleys mounted at fixed positions relative to the drive bar;
a continuous loop relating cable fitted taut about the relating pulleys;
a linkage connecting the relating cable in a fixed position on the header plate;
a first bracket joining the first door hanger to the drive bar, whereby motion of the drive bar is directly transmitted to the first elevator door to position the first elevator door as the drive bar is slideably positioned by the cogbelt along the length of the bar guide;
a second bracket connecting the third door hanger to the relating cable, wherein motion of the drive bar along the bar guide results in movement of the relating cable and translation movement of the third door hanger to position the second elevator door as the drive bar is slideably positioned by the cogbelt along the length of the bar guide;
at least two limit switches mounted in fixed position on said header plate for detecting movement of the drive bar to a fully open position and a fully closed position; and
a gate switch mounted in fixed position on said header plate for sensing movement of a leading one of said door hangers to a fully closed position on the door guide track.

3. An elevator door operator comprising:
an elongate header plate;
an arrangement of components assembled and arranged on said header plate as an integral unit and comprising:
at least one door guide track mounted and leveled in fixed position on said header plate;
a drive motor mounted to said header plate;
a drive pulley mounted on said header plate and structured and disposed for driven rotation by the drive motor;
an idler pulley mounted to said header plate and spaced from the drive pulley;
a continuous loop cogbelt drivingly engaged on the drive pulley and the idler pulley;
an elongate bar guide on said header plate;
a drive bar slideably mounted on the bar guide and connected to the cogbelt so that motion of the cogbelt is directly transmitted to the drive bar for translational movement of the drive bar along the bar guide;
at least two door hangers slideably mounted on the at least one door guide track, the at least two door hangers being structured and disposed for supporting at least one elevator door;
a pair of spaced apart relating pulleys mounted at fixed positions relative to the drive bar;
a continuous loop relating cable fitted taut about the relating pulleys;
a linkage connecting the relating cable in a fixed position on the header plate;
a bracket connecting one of the at least two door hangers to the relating cable, wherein motion of the drive bar along the bar guide results in translational movement of the one of the at least two door hangers along the at least one door guide track;
at least two limit switches mounted in fixed position on said header plate for detecting movement of the drive bar to a fully open position and a fully closed position;
a gate switch mounted in fixed position on said header plate for sensing movement of a leading one of said door hangers to a fully closed position on the door guide track; and
a computer controller communicating with the drive motor, the at least two limit switches and the gate switch, and the computer controller being adapted to receive electric signals from the at least two limit switches and the gate switch and the computer controller being further structured and disposed for outputting electric signals to the drive motor in order to operate the drive motor at a programed speed and direction.

4. The elevator door operator as recited in claim 3 wherein the computer controller includes a self-contained LED display screen.

5. The elevator door operator as recited in claim 4 wherein the computer controller is structured and disposed for running onboard diagnostics, inputting operating parameters, and changing operating parameters.
